(19) United States
(12) Patent Application Publication
(10) Pub. No.: US 2012/0168598 A1
(43) Pub. Date: Jul. 5, 2012

(54) Umbrella Attachment For A Car

(76) Inventors: Michael D. Walker, Tucker, GA (US); Leonard Lay, Ellenwood, GA (US); Clinton Ages, Atlanta, GA (US); Odis Richardson, Marietta, GA (US)

(21) Appl. No.: 12/981,975

(22) Filed: Dec. 30, 2010

(51) Int. Cl. F16M 13/02

(52) U.S. Cl. 248/539

(57) ABSTRACT

The device is a portable umbrella attachment used to mount on the frame of any glass embedded automobile door. It is equipped to support the weight and torque of an umbrella during adverse weather conditions. The device extends the functionality of an umbrella to allow it to serve as a shield and limit weather elements like rain, hail, and snow from entering the user's open automobile door. It also protects the driver or passengers from bad weather elements while they enter, exit or stand by the automobile. The affixing mechanism is designed to apply enough forceful pressure such as a squeezing/gripping motion to secure the umbrella's handle into the device or securely attach the device to a glass embedded automobile door frame. Thus, the user can singlehandedly maneuver this motion. The device has an adjustable shaft; thus, the user can change the direction of the umbrella depending on the situation.

### BACKGROUND OF THE INVENTION

1. Field of the Invention

The present invention relates to an umbrella attachment for a car, and more particularly (or specifically) to an umbrella support attached to any glass embedded automobile door frame.

2. Description of Related Art

Using an umbrella holder or attachment or support to attach an umbrella to a table, a stroller, a walker, a wheelchair, a golf bag, a golf cart, a boat, etc. to free hands for doing something else under sun or in the rain is known in the field. The present invention is distinguished from these devices in that the present invention is designed to mount an umbrella to the frame of any automobile door. The present invention extends the functionality of a traditional umbrella to allow it to serve as a shield and limit weather elements like rain, hail, and snow from entering the user's open automobile door. It also protects the driver or passengers from adverse weather elements.

The previous efforts to use an umbrella unit attached to a car during bad weather to prevent driver and passengers from getting wet when entering into or getting out of an automobile are exemplified by U.S. Pat. No. 5,150,728 to Stark, U.S. Pat. No. 4,562,849 to Sirota, U.S. Pat. No. 5,529,368 to Cui, and U.S. Pat. No. 6,959,715 to Siegel. These patents disclose an umbrella unit or relate to umbrella improvements. The present invention is distinguished from these devices in that the present invention is an umbrella attachment, which universally supports conventional umbrella and can be easily attached to or detached from an automobile.

Utilizing a device to mount an umbrella on a car for providing shelter from bad weather is known in the devices. More specifically, by way of example, U.S. Pat. No. 4,543,971 to Sirota discloses an umbrella holder, which stores the umbrella in a closed position and ejects the umbrella into an opened position. However, deployment occurs through a complicated, expensive mechanism that is not adapted for use with conventional umbrellas. Moreover, umbrellas holder of this device cannot readily be separated from the car and used at multiple locations of the car. The present invention is different from this device in that the present invention can be used with conventional umbrellas and can be easily attached to and detached from an automobile so that it can be used at multiple locations on any glass embedded automobile door.

U.S. Pat. No. 6,213,137 to Wang discloses an umbrella opening device for a vehicle that shares similar concerns of the U.S. Pat. No. 4,543,971 to Sirota; the device is complicated, expensive and is not adapted for use with conventional umbrellas and cannot be separated from the car and used at multiple locations of the car.

U.S. Pat. No. 5,188,331 to Baines describes an umbrella support bracket for use with the trunk of a car while the present invention discloses an attachment used on any glass embedded automobile door frame. The present invention extends the functionality of a traditional umbrella to allow it to serve as a shield and limit weather elements like rain, hail, and snow from entering the user's open automobile. It can also protect drivers and passengers from getting wet when they enter or get out of the car. Thus, it indirectly prevent people from catching cold due to getting wet, especially for people who are more susceptible to cold such as babies or old people. It can be used at multiple locations on any glass embedded automobile door.

### SUMMARY OF THE INVENTION

It is an object of the present invention to provide a device that supports an umbrella mounted on any automobile door frame to provide a shield so as to limit the adverse weather elements (rain or hail or snow) from entering the user's open automobile door and protect the user (driver or passenger) from adverse weather elements when getting in or out of a car or standing by a car.

It is an additional object of the invention to provide an umbrella attachment, which is capable of adjustment to fit almost all types of umbrella.

It is an additional object of the invention to provide an umbrella attachment which is capable of adjustment to fit almost all types of automobile door frame.

It is an additional object of the invention to provide an umbrella attachment which is capable of adjustment in the position of the umbrella relative to the individual so as to provide optimum protection from precipitation.

It is an additional object of the invention that an adjustable umbrella support is easily mounted or removed from the automobile.

It is an additional object of the invention that an adjustable umbrella support is portable and is convenient to carry.

The device is a portable umbrella attachment used to mount to the frame of any automobile door. It is equipped to support the weight and torque of an umbrella used during adverse weather conditions such as wind, rain, hail, and snow. The device extends the functionality of a traditional umbrella to allow it to serve as a shield and limit weather elements like rain, hail, and snow from entering the user's open automobile door.

The user of the device will insert the straight handle of an open umbrella into the device top-end and use a squeezing/gripping motion to secure the umbrella's handle into the device. The user will then open the automobile door where the umbrella's usage is desired. At that time the user will singlehandedly grapple the device and squeeze it to secure it to the opened glass embedded automobile door frame. The affixing mechanism of the device is designed to apply enough forceful pressure to securely adhere to the extended umbrella and adequately provide a sheltered coverage from the falling weather elements. The device's vertical shaft position is adjustable such that the angle of the covering umbrella can be directionally modified by the user with a maximum angular range of +/−30 degrees of the 180 degree baseline/straight-line position.

Upon completion of use, the user simply singlehandedly activates the automobile door mount release mechanism to remove the device from the vehicle. To release the umbrella, the user singlehandedly activates the umbrella handle release mechanism.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

FIG. 1 is a perspective view of one embodiment of the umbrella attachment of the present invention. The umbrella handle support, the vertical shaft, and the automobile door mount forms a 180 degree baseline/straight line relative to the automobile door frame in this figure.

FIG. 2 is a detailed perspective view of the umbrella handle support and the umbrella handle fastening/release mechanism of one embodiment of the umbrella attachment of the present invention.

FIG. 3 is a detailed perspective view of the automobile door mount and automobile door mount fastening/release mechanism of one embodiment of the umbrella attachment of the present invention.

### DESCRIPTION OF THE PREFERRED EMBODIMENT

The invention disclosed herein provides an umbrella attachment, which is mounted on any glass embedded automobile door frame to support an umbrella so that the driver or passengers can get protection from bad weather and have free hands to hold a baby or carry things at the same time when they enter into or get out of a car or stand by the car loading or unloading stuff or putting a baby in or taking a baby out of a car seat or helping an old or handicapped person getting in or out of a car. Furthermore, it limits the adverse weather elements like rain, hail, and snow from entering the user's open automobile door.

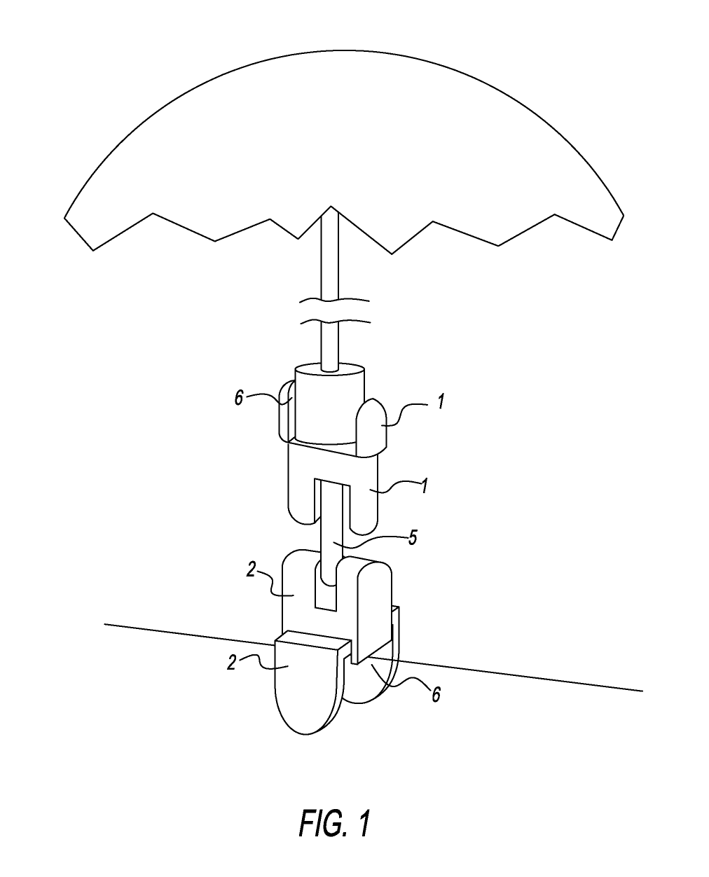

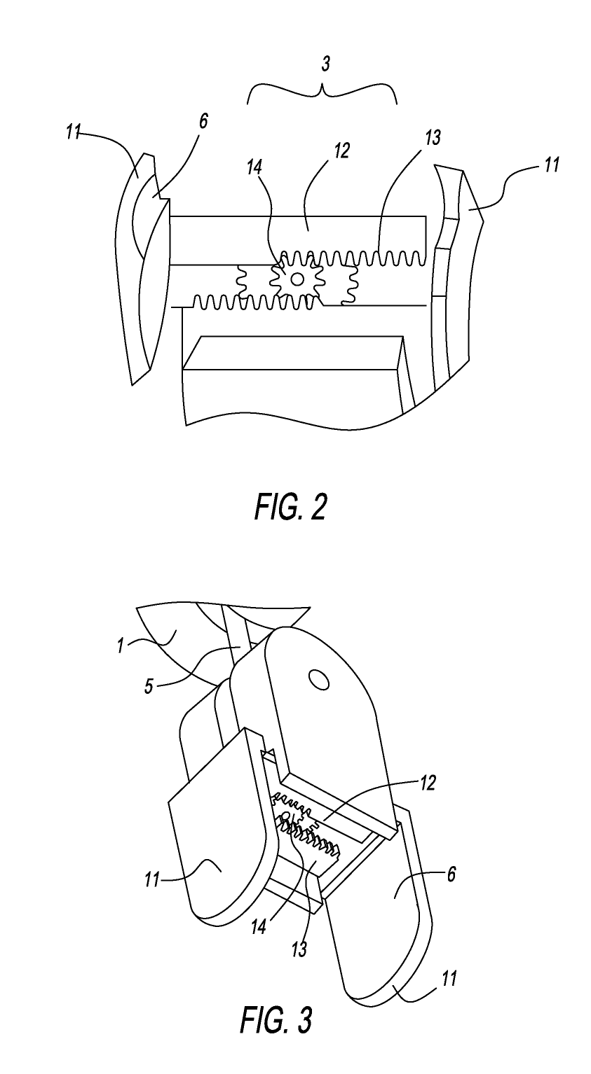

FIG. 1 describes an embodiment of the umbrella attachment of the present invention, which comprises seven major components, umbrella handle support 1, automobile door mount 2, umbrella handle fastening/release mechanism 3 (disclosed in FIG. 2), automobile door mount fastening/release mechanism (disclosed in FIG. 3), adjustable shaft 5, a gel mounting support 6, and a locking mechanism to lock the adjustable shaft when it is in the selected position. The umbrella handle support 1 is designed to attach/detach an umbrella through a fastening/release mechanism 3, which is known in the art. The umbrella handle support 1 is connected to the automobile door mount 2 through an adjustable shaft 5. The automobile door mount 2 is used to attach to or detach from the frame of any glass embedded automobile door through a fastening/release mechanism, which is known in the art. The umbrella handle support 1 comprises a pair of opposite arms which are parallel to each other and have grooves to place the handle of the umbrella. The automobile door mount 2 also comprises a pair of opposite arms which are parallel to each other. Both arms on the umbrella handle support 1 and on the automobile door mount 2 have gel mounting support 6 on the surfaces that contact with the umbrella handle or automobile door frame so as to provide additional firm grip to hold the umbrella handle and the automobile door frame and to protect the surface of the automobile door frame and the handle of an umbrella from scratching. The vertical position of the adjustable shaft 5 is adjustable such that the angle of the covering umbrella can be directionally modified by the user with a maximum angular range of +/−30 degrees of the 180 degree baseline/straight-line position (as shown in FIG. 1). Once the angle of the adjustable shaft 5 is selected, the adjustable shaft 5 can be locked by the locking mechanism that is known in the art.

The user of the device will insert the straight handle of an umbrella into the umbrella handle support 1, which is located on the top-end of the device, and use a squeezing/gripping motion to secure the umbrella's handle into the handle support 1 of the device via the fastening/release mechanism 3. The user will then open the automobile door. At that time the user will singlehandedly grapple the device and attach the automobile door mount 2 onto the frame of the opened door and squeeze the automobile door mount 2 to secure it to the frame of the opened door. The user will then open the umbrella and get out of the car under the sheltered coverage so that the user will not get wet. After the user gets out of the car, the user simply singlehandedly activates the automobile door mount release mechanism to remove the device from the vehicle. The device may stay with the umbrella as an extension of the umbrella or may be detached. To release the umbrella, the user singlehandedly activates the umbrella handle release mechanism 3. If the user needs to unload stuff or carry a baby out from the passenger side or back seats or help an old or handicapped person out of the car, the same device can be attached to the frame of the opened door of passenger side or back seats following said procedures. The user can stand inside the sheltered coverage and take care of things in an easy pace.

The device can also be used when the user wants to get into the car under bad weather; the user inserts the open umbrella into the umbrella handle support 1, open the door, attach the door mount 2 to the frame of the opened door, get in the car, detach the door mount 2 from the car, retrieve the umbrella, close the door; the device may stay with the umbrella. The user may follow similar procedures using device when the user needs to load stuff or put a baby in a car seat or help an old or handicapped person get in the car. The device affixing mechanism is designed to apply enough forceful pressure to securely adhere to the extended umbrella and adequately provide a sheltered coverage from the falling weather elements. The device's vertical shaft position is adjustable so that the direction of shelter coverage can be adjusted and locked depending on the situation.

Furthermore, the shelter coverage that the umbrella on the device provides can limit the adverse weather elements from entering the user's open automobile door.

In one of the embodiments, the umbrella handle support 1 is essentially a clamp consisting of two opposite arms 11 parallel to one another (as shown in FIG. 2). Each arm is perpendicularly located at one end of their respective elongated member 12. The two elongated members are located in a cavity of the umbrella handle support 1 in a parallel arrangement. Part of the elongated members has gear racks 13 on the sides that face each other and are connected through a stationary gear 14. All these components combined function as the umbrella handle fastening/release mechanism 3.

To close the clamp, each arm 11 is pushed towards one another. While the arm is pushed towards each other, the teeth of the gear rack 13 mesh and travel along the stationary gear 14. The umbrella's handle will be placed in between the arms 12 of the umbrella handle support 1, and the arms 11 will be pushed or squeezed until they firmly hold the umbrella. The distance between the two arms 11 can be easily adjusted through the gear mechanism so that the umbrella handle support 1 can fit most of the umbrella handles. When a position is chosen, the teeth of the gear rack 13 on the elongated member 12 will mesh and stay in place with the corresponding stationary gear teeth 14. This clamp/gear mechanism can be singlehandedly maneuvered by the user.

To release the clamp, the arms 11 just need to be pulled away from one another. When an arm 11 is pulled, the teeth of the gear rack 13 on the elongated members 12 will be released from the stationary gear 14, and then mesh and travel along the stationary gear 14 until the umbrella is released. In other embodiments, a different fastening or releasing mechanism known in the art can be applied to affixing or releasing the umbrella to or from the device.

The same type of clamp/gear mechanism can be applied to attaching or releasing the automobile door mount 2 (as disclosed in FIG. 3) to or from a glass embedded automobile door frame. Thus, the automobile door mount 2 can fit most of the glass embedded automobile door frame. In other embodiments, a different fastening or releasing mechanism known in the art can be applied to affixing or releasing the device to or from the automobile.

In another embodiment, the device further comprises one or two releasing control mechanism (not shown in the drawings) which controls the releasing mechanism of the umbrella handle support 1 and/or the releasing mechanism of the automobile door mount 2. The control mechanism may include a button and other mechanical parts that are known in the art.

In one of the embodiments, the umbrella attachment is made of plastic and is compact in size so that it is convenient to carry.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

1. A portable umbrella attachment for mounting an umbrella on an automobile door frame comprising:
(a) an umbrella handle support for holding a handle of an umbrella;
(b) an automobile door mount for attaching to a glass embedded automobile door frame;
(c) an umbrella handle fastening/release mechanism for fastening or releasing the umbrella from said umbrella handle support;
(d) an automobile door mount fastening/release mechanism for fastening or releasing said automobile door mount from the automobile door frame;
(e) an adjustable shaft connecting said umbrella handle support and said automobile door mount;
(f) a locking mechanism for locking said adjustable shaft in a selected position; and
(g) a gel mounting support to provide additional firm grip to grasp the umbrella handle and the automobile door frame and prevent the automobile door frame or the umbrella handle from physical damage.

2. The umbrella attachment of claim 1, wherein said umbrella handle fastening/release mechanism is a clamp/gear mechanism.

3. The umbrella attachment of claim 1, wherein said automobile door mount fastening/release mechanism is a clamp/gear mechanism.

4. The umbrella attachment of claim 1, wherein said umbrella holder support having a pair of opposite arms; each said arm has a groove for holding the umbrella handle.

5. A portable umbrella attachment for mounting an umbrella on an automobile door frame comprising:
(a) an umbrella handle support for holding a handle of an umbrella, said umbrella handle support comprising a pair of opposite arms, each said arm has a groove for holding the umbrella handle;
(b) an automobile door mount for attaching to a glass embedded automobile door frame;
(c) an umbrella handle fastening/release mechanism for fastening or releasing the umbrella from said umbrella handle support, said umbrella handle fastening/release mechanism is a clamp/gear mechanism;
(d) an automobile door mount fastening/release mechanism for fastening or releasing said automobile door mount from the automobile door frame, said automobile door mount fastening/release mechanism is a clamp/gear mechanism;
(e) an adjustable shaft connecting said umbrella handle support and said automobile door mount;
(f) a locking mechanism for locking said adjustable shaft in a selected position; and
(g) a gel mounting support to provide additional firm grip to grasp the umbrella handle and the automobile door frame and prevent the automobile door frame or the umbrella handle from physical damage.

6. A portable umbrella attachment for mounting an umbrella on an automobile door frame being made of plastic material, in a compact size comprising:
(a) an umbrella handle support for holding a handle of an umbrella, said umbrella handle support comprising a pair of opposite arms, each said arm has a groove for holding the umbrella handle;
(b) an automobile door mount for attaching to a glass embedded automobile door frame;
(c) an umbrella handle fastening/release mechanism for fastening or releasing the umbrella from said umbrella handle support, said umbrella handle fastening/release mechanism is a clamp/gear mechanism;
(d) an automobile door mount fastening/release mechanism for fastening or releasing said automobile door mount from the automobile door frame, said automobile door mount fastening/release mechanism is a clamp/gear mechanism;
(e) an adjustable shaft connecting said umbrella handle support and said automobile door mount; said vertical shaft position is adjustable such that the angle of the covering umbrella can be directionally modified by the user with a maximum angular range of +/−30 degrees of the 180 degree baseline/straight-line position;
(f) a locking mechanism for locking said adjustable shaft in a selected position;
(g) a gel mounting support to provide additional firm grip to grasp the umbrella handle and the automobile door frame and prevent the automobile door frame or the umbrella handle from physical damage;
(h) a release control mechanism for controlling said release mechanism of said umbrella handle support, said release control mechanism may include a button or a switch; and
(i) a release control mechanism for controlling said release mechanism of said automobile door mount, said release control mechanism may include a button or a switch.

7. The umbrella attachment of claim 1 further comprising a release control mechanism for controlling said release mechanism of said umbrella handle support; said release control mechanism may include a button.

8. The umbrella attachment of claim 1 further comprising a release control mechanism for controlling said release mechanism of said automobile door mount; said release control mechanism may include a button.

9. The umbrella attachment of claim 1, wherein said vertical shaft position is adjustable such that the angle of the covering umbrella can be directionally modified by the user with a maximum angular range of +/−30 degrees of the 180 degree baseline/straight-line position.

10. The umbrella attachment of claim 1 is made of plastic material.

11. The umbrella attachment of claim 1 is compact in size.

12. The umbrella attachment of claim 1 is equipped to support the weight and torque of an umbrella used during adverse weather conditions.
